(19) United States
(12) Patent Application Publication
(10) Pub. No.: US 2025/0180811 A1
(43) Pub. Date: Jun. 5, 2025

(54) BEAM GUIDE DEVICE FOR GUIDING SIGNAL LIGHT RADIATION

(71) Applicant: FIBERBRIDGE PHOTONICS GMBH, Hannover (DE)

(72) Inventor: Thomas THEEG, Seelze (DE)

(21) Appl. No.: 18/960,194

(22) Filed: Nov. 26, 2024

(30) Foreign Application Priority Data
Nov. 30, 2023 (DE) 102023133492.1

(51) Int. Cl. G02B 6/26; G02B 6/02; G02B 6/32; G02B 6/36

(52) U.S. Cl. CPC G02B 6/262; G02B 6/02395; G02B 6/32; G02B 6/3672

(57) ABSTRACT

The present invention relates to a beam guide device for guiding signal light radiation, having at least one fiber input element which is designed to receive the signal light radiation, having at least one fiber output element which is designed to emit the signal light radiation, and having a plurality of fiber elements which are fastened at one end to the fiber input element and at the opposite end to the fiber output element and are designed to guide the signal light radiation from the fiber input element to the fiber output element.

The present invention relates to a beam guide device for guiding signal light radiation.

Nowadays, glass fibers are used in many different technical fields. The technical and particularly high-technical applications include the use of glass fibers for light transmission. Thus, glass fibers are used for data transmission by means of light; in this case, the glass fibers can also be referred to as optical waveguides or passive optical fibers. Glass fibers are also used in medicine for example for illumination and for producing images, for example in microscopes, in inspection cameras and in endoscopes. Furthermore, glass fibers are used in sensors which can then be referred to as fiber-optic sensors.

A further field of application for glass fibers is laser technology. Here, the laser radiation can be guided as a signal light beam by means of a passive glass fiber from a laser radiation source as a signal light source or as a signal light beam source to a processing point in order to carry out there, for example in material processing or in medicine, for example, cutting or welding. The laser beam can also be fed to a sample as laser radiation in this way, for example in measurement technology, microscopy or spectroscopy. The use of passive glass fibers for guiding a laser beam can take place, for example, in applications such as mechanical engineering, telecommunications, medical technology and sensor technology.

Glass fibers can also be used to generate or amplify laser light and are referred to as active glass fibers. Fiber lasers for generating laser light or fiber amplifiers for amplifying laser light have, in sections, a doped fiber core (see below), which forms the active medium of the fiber laser or of the fiber amplifier, i.e. its active glass fiber. Common doping elements of the laser-active fiber core are in particular neodymium, ytterbium, erbium, thulium and holmium. Fiber lasers or fiber amplifiers are used, inter alia, in the industry for ultrashort pulse laser systems (for example at a wavelength of about 1 μm), in measurement technology (for example for LIDAR measurements—laser detection and ranging), in medical applications (for example at a wavelength of about 2 μm) or in space applications (for example at a wavelength of about 1.5 μm).

Glass fibers, which are used to amplify signal light such as laser radiation in fiber amplifiers or to generate laser radiation in fiber lasers, usually have a fiber core, which consists of pure glass such as pure quartz glass and, in the case of passive glass fibers, is often doped with germanium; in the case of active glass fibers, doping is usually carried out as described above. In certain cases, the fiber cladding can also be doped; this applies to both passive and active glass fibers. Depending on the size and the numerical aperture of the fiber core, it is possible to distinguish between single-mode and multi-mode glass fibers. In addition, the fiber core can still have polarization-maintaining properties for the light and can therefore be referred to as polarization-maintaining optical fibers (PM). They can also be photonic crystal glass fibers and hollow-core glass fibers. Even if the main field of application relates to glass fibers, polymer fibers or fibers made of other materials, for example so-called soft glass fibers for the mid IR range, can likewise be used for such applications.

The fiber core is usually surrounded radially from the outside by at least one fiber cladding, which is usually closed in the circumferential direction and thus completely surrounds the fiber core, apart from the two open ends of the glass fiber. The fiber cladding is also usually made of quartz glass.

Usually, both passive glass fibers and active glass fibers are surrounded by a fiber coating made of polymer, for example, comparable to the fiber cladding, which can then be attributed to the glass fiber. The fiber coating can serve to mechanically protect the glass interior of the glass fiber and influence the optical properties thereof. In the case of glass fibers in which the light is guided exclusively in the fiber core (single-clad glass fibers), the fiber coating is usually primarily used for mechanical protection. Glass fibers which guide light in the fiber core and in the fiber cladding (double-clad glass fibers) are usually designed with a fiber coating for fulfilling mechanical and optical properties.

Two cross-sectional shapes that occur frequently in practice for the fiber cladding are cylindrical and octagonal. The octagonal shape for the fiber cladding is used in particular in the case of active glass fibers.

Such glass fibers can be produced in large lengths and are usually available as roll products. The diameter of the fiber cladding usually varies between approximately 80 μm and approximately 1 mm. The larger fiber diameters in particular are often referred to in practice as rod-type fibers.

Signal light or signal light radiation can thus be supplied via a glass fiber, which is therefore referred to as a beam guide device and which can be implemented as a cable or beam feed cable. Beam feed cables for guiding the signal light radiation from the laser system to the application or to the location of the application are now commonly implemented with exactly one glass fiber per beam feed cable.

As already mentioned, the fiber optic cable offers the great advantage that the light from the signal light radiation can be guided flexibly over long distances within the fiber optic cable, e.g. on a robot arm, and reliably to the application location. At the application location, the individual optical fiber typically emits a round laser beam from a single-mode or multi-mode optical fiber.

However, the trend on the market shows that a modified laser beam, i.e. with a special beam profile that is not perfectly round, is desired for many applications such as welding, additive manufacturing and surface treatment, as well as for the cleaning of materials. This can result in significant benefits for the given application, and better or new technical solutions can thus be implemented or lower unit costs achieved.

There are already various beam shaping approaches for modifying or shaping the individual round laser beam from the beam feed cable for the application. This brings great advantages for some applications.

However, for technical reasons, many interesting or necessary laser beam configurations cannot as yet be achieved. In addition, power transport via a single optical fiber reaches its limits for physical and technical reasons.

Furthermore, for many applications it is desirable to increase the available optical power for the corresponding application at the application location, for example in order to be able to weld better or to implement additive manufacturing processes more quickly (e.g. selective laser melting).

In any case, it is useful or necessary for many applications to guide, direct or transmit the signal light radiation over a certain distance, in particular from the location where the signal light radiation is generated or amplified, in order to use, amplify or modify the signal light radiation there.

An object of the present invention is to improve or expand the possibilities for guiding signal light radiation, in particular on the path from the laser source to the use or application. In particular, the challenges described above should be at least partially addressed or overcome. The fiber exit element is to be as simple, cost-effective and/or space-saving as possible. The intention is to at least create an alternative to the known possibilities.

The object is achieved according to the invention by a beam guide device for guiding signal light radiation and by a device according to the independent claims. Advantageous further developments are described in the subclaims.

The present invention thus relates to a beam guide device for guiding signal light radiation, having at least one fiber input element which is designed to receive the signal light radiation, having at least one fiber output element which is designed to emit the signal light radiation, and having a plurality of fiber elements which are fastened at one end to the fiber input element and at the opposite end to the fiber output element and are designed to guide the signal light radiation from the fiber input element to the fiber output element.

According to the invention, multiple, i.e., at least two, fiber elements can thus be connected to one another in a fixed manner not only at their inputs or input ends by means of the shared fiber input element but also at their outputs or output ends by means of the shared fiber output element, in order to guide signal light radiation or individual signal light beams parallel to one another, preferably in the same propagation direction. The fiber elements in-between, i.e. between the fiber input element and the fiber output element, can be unconnected, i.e. loosely connected to one another, or be connected to one another, in particular by means of a shared housing or by means of a shared cladding, wherein bundles of fiber elements can also be formed initially, which are then jointly enclosed by a cladding.

In any case, a beam guide device can be created according to the invention in order to guide a plurality of signal light beams through the fiber elements parallel to one another from the fiber input element to the fiber output element, so that the signal light beams can be generated and/or amplified at the fiber input element end, and applied or used together at the fiber output element end. This can expand or improve the possible uses. The fiber elements can comprise passive and/or active glass fibers or glass fiber sections, and preferably consist thereof.

The reception of the signal light radiation or of the signal light beams via the fiber input element can be realized via a free-beam coupling into the fiber elements or via a material connection (e.g. fiber splice connection) with the fiber elements. The fiber input element can thus be functionally regarded as an interface for transferring the signal light radiation from the laser source or the like to the beam guide device, which can be done with or without contact. This interface is represented by the fiber input element, regardless of whether a free-beam coupling or a fiber-based connection from the beam guide device or its fiber input element to the laser source or the like is used. This applies correspondingly to the fiber output element.

According to one aspect of the invention, the ends of the fiber elements are fused in the fiber input element and/or in the fiber output element. This can represent a possibility of a fixed, materially-bonded connection at the corresponding location of the beam guide device according to the invention. In this way, the properties and advantages of such a fused connection can also be applied here.

According to a further aspect of the invention, the fiber input element has a recess or a through-opening for each fiber element-facing the fiber elements-in which the end of the fiber element is received, and/or the fiber output element has a recess or a through-opening for each fiber element-facing the fiber elements-in which the end of the fiber element is received. In any case, the fiber element can project with its corresponding end into the material of the fiber input element or into the material of the fiber output element in this way, so that a lateral stabilization and/or a lateral hold of the fiber element can be effected. This can be done by fusing the end of the fiber element within the material of the fiber input element or of the fiber output element, which can promote or improve the fusing. In the case of a through-opening, the fusion can take place at the edge in order to keep the end of the fiber element open so that the signal light radiation can enter or exit. The material for the fiber input element and/or for the fiber output element can be selected accordingly to achieve optimal optical, thermal and/or mechanical properties. One promising material here is quartz glass.

According to a further aspect of the invention, at least some, preferably all, fiber elements have at least one pumped light trap. The properties and advantages of cladding light strippers or cladding power strippers can be applied and utilized in the beam guide device according to the invention.

Preferably, the cladding light strippers are each arranged on the fiber input element and/or on the fiber output element. The cladding light strippers at the fiber input element or at the fiber output element can remove light that is interfering for the application, typically from the cladding of the fiber elements. Interference light, for example, from the fiber coupling or a fiber splice connection, can result at the fiber input element and can occur at the fiber output element, for example from application-related reflected light. This can also facilitate a compact implementation of the beam guide device, since the cladding light strippers can be kept away from the elongated course of the fiber elements.

According to a further aspect of the invention, the fiber input element has an optical coating, preferably an anti-reflection coating, facing away from the fiber elements and/or the fiber output element has an optical coating, preferably an anti-reflection coating, facing away from the fiber elements. This optical coating can thus be provided at the fiber input element end and/or the fiber output element end, from where the signal light radiation enters or where the signal light radiation exits. In any case, the optical coating can improve the optical efficiency of the overall system and minimize interfering reflections, especially at high optical powers.

According to a further aspect of the invention, the fiber input element has an optical coating around the fiber elements, facing the fiber elements-preferably, a reflection coating and/or an absorption coating-and/or the fiber output element has an optical coating around the fiber elements, facing the fiber elements-preferably, a reflection coating and/or an absorption coating. Accordingly, other radiation entering the fiber input element and/or the fiber output element in the direction in which the fiber elements are arranged can otherwise be influenced and, according to the present aspect of the invention, can be safely dissipated from the fiber input element and/or the fiber output element in particular by the optical coating as a reflection coating and/or by the optical coating as an absorption coating, in order to prevent possible damage or destruction of the beam guide arrangement.

According to a further aspect of the invention, the fiber input element has at least one, preferably air-or water-cooled, absorption and/or reflection element around the fiber elements, facing the fiber elements and/or the fiber output element has at least one, preferably air-or water-cooled, absorption and/or reflection element around the fiber elements, facing the fiber elements. In addition to or as an alternative to the previously described reflection coating and/or absorption coating, this can act as an optical coating to divert unwanted radiation from the fiber input element and/or from the fiber output element. The absorption and/or reflection element can be integrated into the fiber input element and/or into the fiber output element or be part of the fiber input element and/or the fiber output element.

Preferably providing air-or water-cooling of the absorption and/or reflection element can promote the dissipation of the thermal energy absorbed there.

According to a further aspect of the invention, the fiber input element has, facing away from the fiber elements, an input lens for each incoming beam of signal light radiation, preferably provided with an optical coating, preferably with an anti-reflection coating and/or the fiber output element has, facing away from the fiber elements, one output lens for each exiting beam of signal light radiation, preferably provided with an optical coating, preferably with an anti-reflection coating. This allows the incoming signal light radiation to be bundled by means of the corresponding input lens. By means of the corresponding output lens, the emerging signal light radiation can be collimated or focused. Providing an optical coating, such as in particular an anti-reflection coating, can here make possible the use or application of the corresponding properties and advantages described above in this location as well.

According to a further aspect of the invention, the fiber input element has a single input element per fiber element, wherein the single input elements are fastened to one another by means of a carrier and/or the fiber output element has a single output element per fiber element, wherein the single fiber output elements are fastened to one another by means of a carrier. This can represent an alternative to a one-piece, i.e. integral, fiber input element or fiber output element which accommodates multiple or all fiber elements, such that the design freedom of the implementation can be increased.

According to a further aspect of the invention, the carrier comprises glass, metal or ceramic, and preferably consists of these. This allows the corresponding optical, thermal and/or mechanical material properties to be used at this location.

According to a further aspect of the invention, the carrier has at least in portions, preferably substantially, a preferably optically reflective and/or optically adsorbent surface coating. As a result, the corresponding properties and advantages described above can also be used at this location. The optically reflective and/or optically adsorbent property of the surface coating can be implemented or achieved in particular by a corresponding material property of the surface coating.

According to a further aspect of the invention, the fiber input element and/or the fiber output element has at least one spacer element which runs perpendicular to the fiber elements and is designed to receive the signal light radiation and emit it to the fiber elements, wherein the spacer element is spaced apart from the fiber elements by a preferably open, gas-filled, liquid-filled, solid-filled or vacuum-filled intermediate space and/or the fiber output element has at least one spacer element which runs perpendicular to the fiber elements and is designed to receive the signal light radiation from the fiber elements and emit it away from the beam guide device, wherein the spacer element is spaced apart from the fiber elements by a preferably open, gas-filled, liquid-filled, solid-filled or vacuum-filled intermediate space. In this way, an intermediate space can be created in each case, through which the signal light radiation passes and/or is guided. Filling the intermediate space enables the signal light radiation to be influenced.

According to a further aspect of the invention, the surface of the spacer element facing away from the fiber elements has an optical coating, preferably an anti-reflection coating and/or the surface of the spacer element facing the fiber elements has an optical coating, preferably an anti-reflection coating. As a result, the corresponding properties and advantages described above can also be implemented at this location.

According to a further aspect of the invention, the fiber elements are connected, facing the spacer element, to the intermediate space via through-openings of the fiber input element or of the fiber output element, preferably recessed, or the fiber elements, facing the spacer element, are received by recesses in the fiber input element or the fiber output element, preferably recessed. This can constitute a possibility for permanently connecting the fiber elements to the fiber input element and for allowing the signal light radiation from the intermediate space to enter the ends of the fiber elements. This may lead to an advantageous design of the beam guide device for some types of glass fiber, e.g. for hollow core fibers. The fiber elements themselves can also be provided with an anti-reflection coating on the end faces. For example, if a multi-mode fiber is used as a fiber element and is positioned in a through-opening of a fiber input element or fiber output element, the end face or end faces of the multi-mode fiber can be provided with an anti-reflection coating.

According to a further aspect of the invention, the beam guide device further comprises at least one optical element, preferably at least one collecting lens, which is arranged at a distance from the fiber elements facing away from the fiber input element by means of a holder and is designed to receive some, preferably all, incoming rays of the signal light radiation and/or the beam guide device further comprises at least one optical element, preferably at least one collecting lens, which is arranged at a distance from the fiber elements facing away from the fiber output element by means of a holder and is designed to receive some, preferably all, outgoing rays of the signal light radiation.

At least one optical element, or multiple optical elements, can thus be provided before and/or after the fiber elements as part of the beam guide device in order to influence the signal light radiation before and/or after passage through the optical elements. This can increase the shaping possibilities for the signal light radiation. Multiple identical and/or different optical elements can be arranged one after the other along the propagation direction of the signal light radiation in order to combine their effects.

According to a further aspect of the invention, the optical element is a microlens array, wherein the microlens array has one microlens per fiber element, multiple microlenses per fiber element, or a shared microlens for multiple fiber elements. A microlens array is a two-dimensional matrix of comparatively small lenses in the micrometer range, usually between approx. 100 μm and approx. 5000 μm, in terms of dimensions, which together form an optical element as an array of such microlenses. Such optical elements can thus also be used in a beam guide device according to the invention.

A microlens array offers a wide range of design and influencing options for the signal light radiation, since the number of microlenses corresponds exactly to the number of fiber elements and these can be arranged exactly opposite each other along the propagation direction of the signal light radiation. However, the number of microlenses and the number of fiber elements can also be different from each other, which can offer additional design options. On the one hand, sufficiently large microlenses or correspondingly small fiber elements or inputs and/or outputs of fiber elements can thus be provided, so that the signal light radiation from multiple fiber elements passes through one and the same microlens. On the other hand, also conversely, a fiber element or its input and/or output can be designed to be comparatively large compared to multiple microlenses, so that the signal light radiation of the fiber element passes through the multiple microlenses and/or the signal light radiation of multiple microlenses enters the same fiber element together. By means of the arrangement options mentioned, the signal light radiation or the signal light beams can be guided and shaped, for example, in order to homogenize the signal light radiation and/or to use the beams for a coherent combination of the individual signal light beams (coherent beam combining) and/or to generate signal light beam patterns.

According to a further aspect of the invention, the beam guide device further comprises a single lens per fiber element for some, preferably all, fiber elements, which is arranged at a distance from the fiber elements and is spaced apart from the fiber output element, and is designed to receive exactly one exiting beam of the signal light radiation. In both cases, this makes it possible to collect or bundle the emerging signal light radiation in order to obtain and use a bundled resulting beam of signal light radiation. Corresponding single lenses per fiber element and/or a global lens for all fiber elements can also be used at or in front of the fiber input element in order to realize the most efficient coupling of the signal light radiation and/or signal light beams into the fiber elements.

According to a further aspect of the invention, some, preferably all, fiber elements are spaced differently, preferably at a greater distance, apart from one another at the fiber input element than at the fiber output element. The spacing of the fiber elements can also be referred to as the packing density. The spacing in this case is perpendicular to the longitudinal extension direction of the fiber elements.

Thus there is no purely parallel transmission or guidance of the signal light radiation through the fiber elements, i.e. not at the same distance from each other. It is rather the case that some or all of the fiber elements at or in the fiber input element have a different distance perpendicular to their elongated extension than at or in the fiber output element. In this way, the outgoing signal light radiation relative to the incoming signal light radiation can be influenced, wherein the effect or properties of the outgoing signal light radiation or of a beam of the individual signal light radiation resulting from the outgoing signal light radiation can also be influenced as signal light radiation.

Providing a greater distance between the fiber elements at or in the fiber input element than at or in the fiber output element, where a smaller distance is thus present, can in particular make possible an increase in the power density of the resulting beam of signal light radiation. By increasing the spacing of the fiber elements at the fiber input element, the coupling of the signal light radiation can be made easier and more efficient and reliable. The fiber elements can vary not only in their spacing but also in the depth of the fiber input elements and/or of the fiber output elements.

According to a further aspect of the invention, some, preferably all, fiber elements at the fiber input element have a different spatial arrangement in relation to one another than at the fiber output element. In this case too, a purely parallel transmission or guidance of the signal light radiation through the fiber elements cannot thus take place, wherein in this case, in addition to or as an alternative to the previously described different distance between the fiber elements, their arrangement or course relative to one another is changed. For example, a linear, i.e. one-dimensional, arrangement of the corresponding ends of the fiber elements can thus be present at the fiber input element end, and the fiber elements can be guided relative to one another in such a way that a two-dimensional arrangement can be provided on the fiber output element-for example, square, rectangular, pentagonal, hexagonal, etc. or circular, oval and the like. Different one-dimensional arrangements of the fiber elements relative to each other at the fiber input element and the fiber output element can also be used, for example by different-even varying-distances between the fiber elements along the one dimension. Likewise, different two-dimensional arrangements can be used on the fiber input element and the fiber output element, for example rectangular or square on the fiber input element and circular on the fiber output element. This can increase the design flexibility in order to influence the resulting beam of signal light radiation.

If the signal light radiation or the signal light beams are coupled by means of a beam guidance and deflection unit into the fiber elements on the fiber input element, the spacing along the longitudinal axis, along the transverse axis and/or along the vertical axis and/or the arrangement of the fiber elements or the adaptation of the fiber cross-sections can be optimally adapted to the beam guidance and deflection unit in order to significantly improve the efficiency, performance and reliability of the overall system. For example, when a galvo scanner, an acousto-optical deflector or other beam deflection system are used, the single fiber elements can be optimally adapted to the beam characteristics or deflection behavior of the galvo scanner or acousto-optical deflector in terms of spacing, spatial arrangement, fiber cross-sections and other properties at the fiber input element.

In addition, an adjustment of the spacing along the longitudinal axis, along the transverse axis and/or along the vertical axis and/or the arrangement of the fiber elements and/or fiber cross-sections at the fiber input element can be advantageous if simultaneously coupling multiple signal light beams into the fiber elements, e.g. when using microlens arrays for fiber coupling-possibly also in combination with a beam deflection system.

According to a further aspect of the invention, some, preferably all, fiber elements are arranged one-dimensionally with respect to each other at the fiber input element and two-dimensionally with respect to each other at the fiber output element. This may constitute a concrete possibility of implementation, in particular for increasing the power density of the resulting beam of signal light radiation, as previously described.

According to a further aspect of the invention, some, preferably all, fiber elements are in each case cylindrical and are formed with a larger cross-section at the fiber input element, preferably in relation to a fiber core, a fiber cladding and/or a fiber coating, than at the fiber output element. For this purpose, in particular two corresponding fiber elements can be connected to form one fiber element by means of a connecting element or a transition element in order to optically adapt the fiber elements to one another at the connecting element if necessary. This can represent a further design possibility for influencing the transmission of the signal light radiation or the resulting beam of the signal light radiation.

According to a further aspect of the invention, some, preferably all, fiber elements are in each case formed with a different contour at the fiber input element than at the fiber output element. For example, the fiber elements on or in the fiber input element can be cylindrical and on or in the fiber output element can be angular, in particular quadrangular or square. For this purpose too, two corresponding fiber elements can be connected to form one fiber element by means of a connecting element or a transition element in order to optically adapt the fiber elements to one another at the connecting element if necessary. This can also increase the design options.

According to a further aspect of the invention, some, preferably all, fiber elements are divided multiple times between the fiber input element and the fiber output element. In other words, exactly one strand per fiber element initially runs from the fiber input element, which is connected to a fiber coupler or to a fiber switch at the end opposite the fiber input element in order to divide the one path of the signal light radiation into multiple paths of the signal light radiation, which are then each fed to a strand of multiple strands of the fiber element, which together end at or in the fiber output element. This makes it possible to split the signal light radiation or to multiply the paths of the signal light radiation, which can also increase the design options. The fiber switches can be designed to be passively or actively controllable or regulatable.

According to a further aspect of the invention, some, preferably all, fiber elements are formed in two parts and are connected to one another, preferably in a materially bonded manner, by means of a connecting element, preferably approximately centrally between the fiber input element and the fiber output element or closer to the fiber input element or to the fiber output element. This may constitute a possibility for implementation as previously described, for example in order to combine strands of the fiber elements having different diameters, contours and the like. These individual strands can be directly connected to each other or even indirectly connected via at least one component arranged in between. Positioning the separation or joining point approximately in the middle can simplify implementation. Moving the separation or joining point towards one end of the fiber elements can promote a more compact design.

According to a further aspect of the invention, some, preferably all, fiber elements are individual flexible fibers, preferably glass fibers, which are held together or in bundles by a flexible material, particularly preferably enclosed by a cladding, and the beam guide device is a fiber optic cable, preferably a glass-fiber optic cable. This can constitute a concrete possibility for implementation. In particular, this makes it possible to create a flexible and thus bendable beam guide device as a fiber-optic cable, which can simplify the routing of the fiber-optic cable to the application. In particular, this can make it very easy to route the fiber-optic cable to a moving application such as the end effector of a robot arm, and in particular an articulated-arm robot. Furthermore, for safety reasons, the fiber-optic cable can contain a sensor for cable breakage protection or a sensor system for unwanted scattered cable radiation.

According to a further aspect of the invention, some, preferably all, fiber elements are aligned obliquely in relation to the fiber input element and/or the fiber output element. The term “obliquely” means a route or an elongated extension that deviates from the vertical and is inclined to the side. “Oblique” can also be understood as the opposite of “straight”. This can increase the number of possible designs.

According to a further aspect of the invention, the fiber input element and/or the fiber output element is/are curved. This can thus make possible a concave or convex shape of the fiber input element and/or of the fiber output element, which can increase the design freedom. The curvature of the fiber input element and/or of the fiber output element can be in both spatial directions. In addition, the curvature can also be achieved gradually by connecting straight segments.

Preferably aligning the fiber elements parallel to the surface normal of the fiber input element and/or of the fiber output element can make it possible to achieve a straight-line transition from the fiber input element into the fiber elements and/or from the fiber elements into the fiber output element despite the curved design. This can lead to an improved and reliable feed of the signal light radiation or signal light beams into the fiber elements and to a use of the signal light radiation or signal light beams at the fiber output element that is improved for the application.

According to a further aspect of the invention, some, preferably all, fiber elements each have at least one fiber core, in each case substantially enclosed by at least one fiber cladding, wherein some, preferably all, fiber cores and/or some, preferably all, fiber claddings comprise, preferably consist of, glass, preferably quartz glass or glass/air material structures. This can constitute a concrete possibility for implementation. The fiber elements can be passively or actively doped (laser-active doping). The fiber elements can also consist of solid glass material, photonic crystal fibers, hollow-core fibers, multi-core fibers or multi-clad fibers.

According to a further aspect of the invention, some, preferably all, fiber claddings are each substantially enclosed by a fiber coating, wherein the fiber coatings comprise, preferably consist of, a softer material than glass, preferably an acrylate, a silicone or a polyimide. This can constitute a concrete possibility for implementation.

The present invention also relates to a device having at least one beam guide device as previously described. The properties and advantages of the previously described beam guide device according to the invention can be implemented in a higher-level device, system or application in order to enable their use them in practice.

In other words, embodiments of a refined beam guide device made of multiple optical fibers can be used to partially or completely overcome the challenges mentioned. However, for many applications, for example in material processing or medical technology, it is relevant to use one or a plurality of laser beams, for the reasons given above, in an arrangement of multiple glass fibers which is as compact as possible and, above all, thermally and mechanically highly stable at the location of use. This makes it possible, for example, to realize a non-coherent or a coherent combination of numerous laser beams or a special beam shaping and/or beam deflection (static or time-modulated). Depending on the target, multiple laser beams can be arranged in a one-or two-dimensional geometric arrangement using glass fibers, and used accordingly at the application location. Furthermore, a laser beam can be coupled into different glass fibers in a 1D or 2D arrangement of glass fibers in a chronologically successive manner, and the resulting beam profile can be used at the output of the beam feed cable, i.e. at the application location.

Several exemplary embodiments and further advantages of the invention are illustrated and explained in more detail below, purely schematically, in connection with the following figures. Shown are:

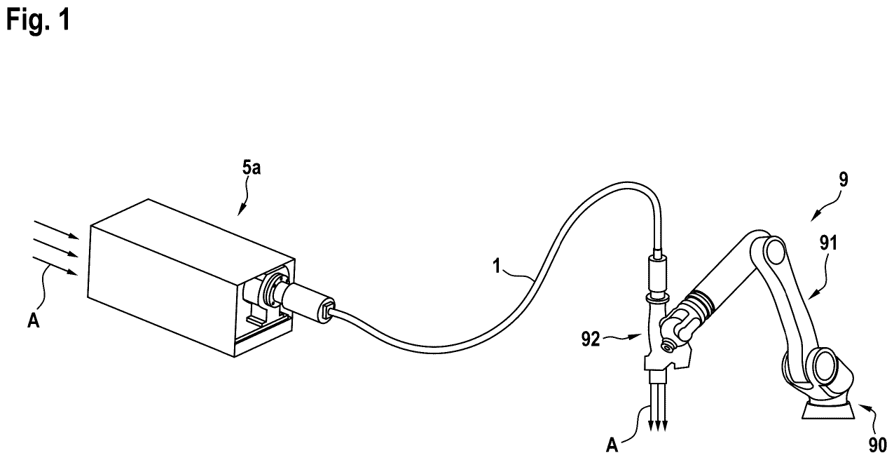

FIG. 1 a perspective view of an application of a beam guide device according to the invention in the form of a fiber-optic cable;

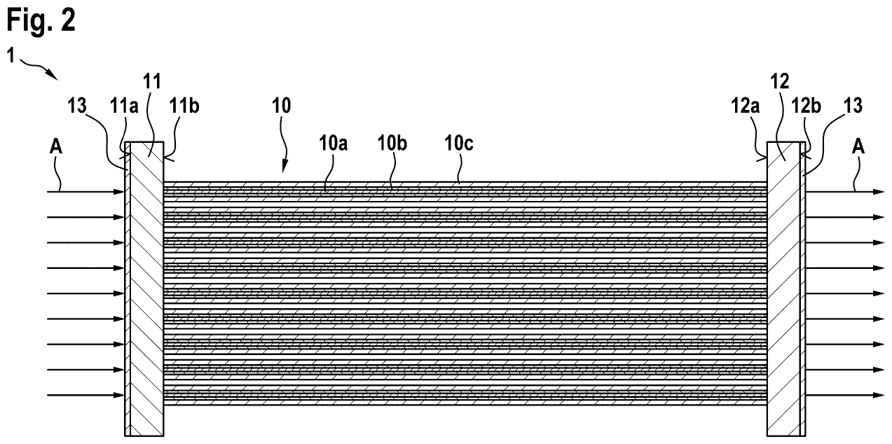

FIG. 2 a horizontal section through a beam guide device according to the invention according to a first exemplary embodiment;

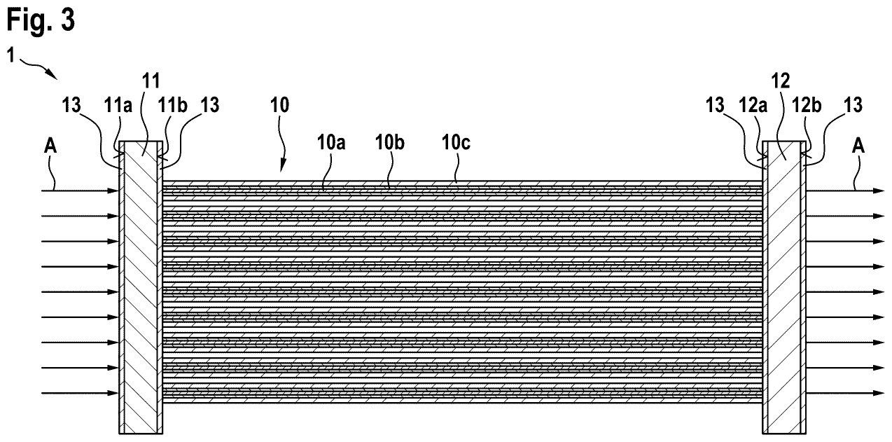

FIG. 3 a horizontal section through a beam guide device according to the invention according to a second exemplary embodiment;

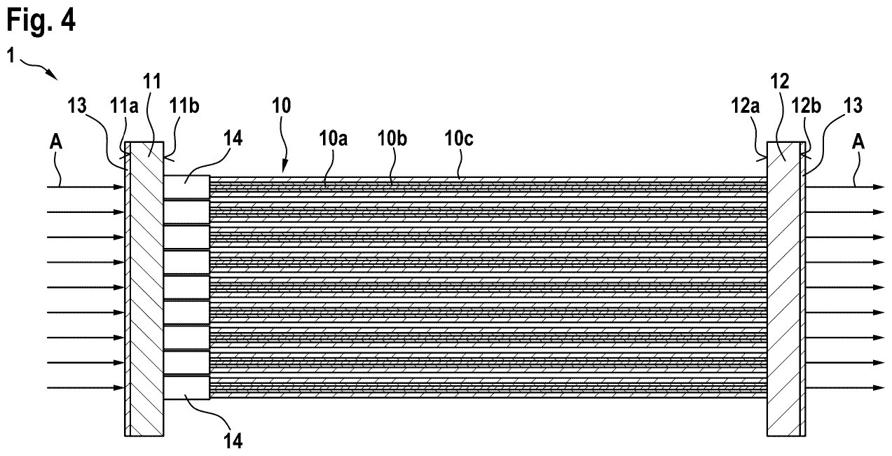

FIG. 4 a horizontal section through a beam guide device according to the invention according to a third exemplary embodiment;

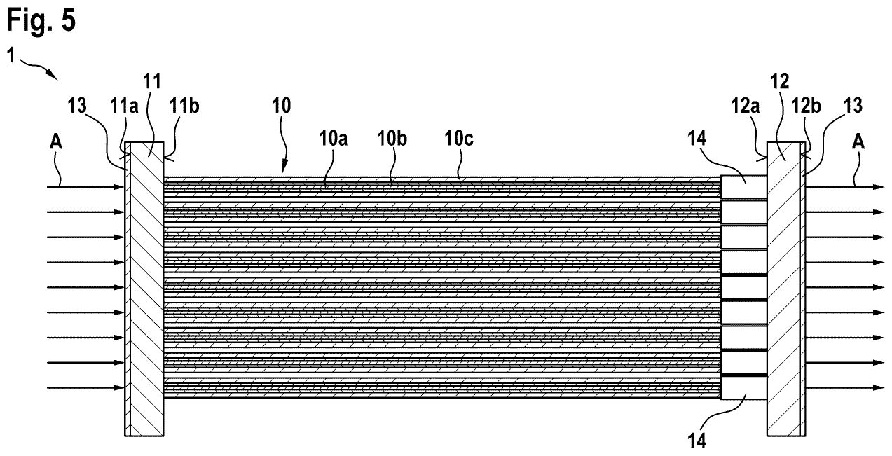

FIG. 5 a horizontal section through a beam guide device according to the invention according to a fourth exemplary embodiment;

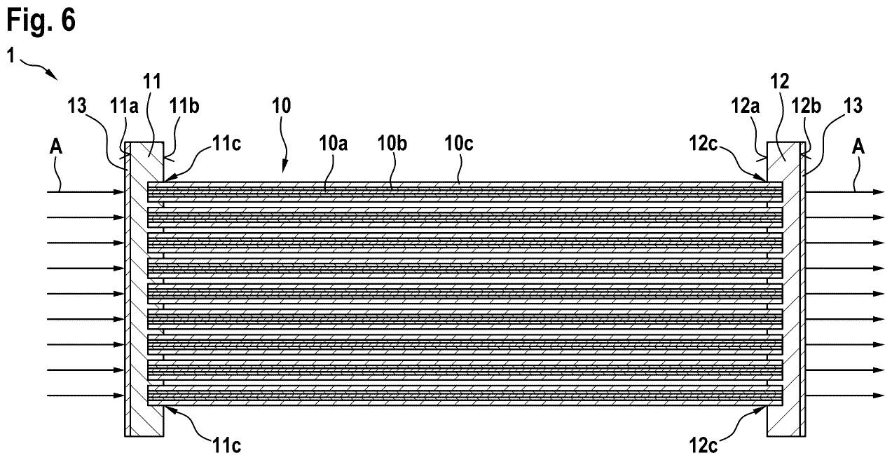

FIG. 6 a horizontal section through a beam guide device according to the invention according to a fifth exemplary embodiment;

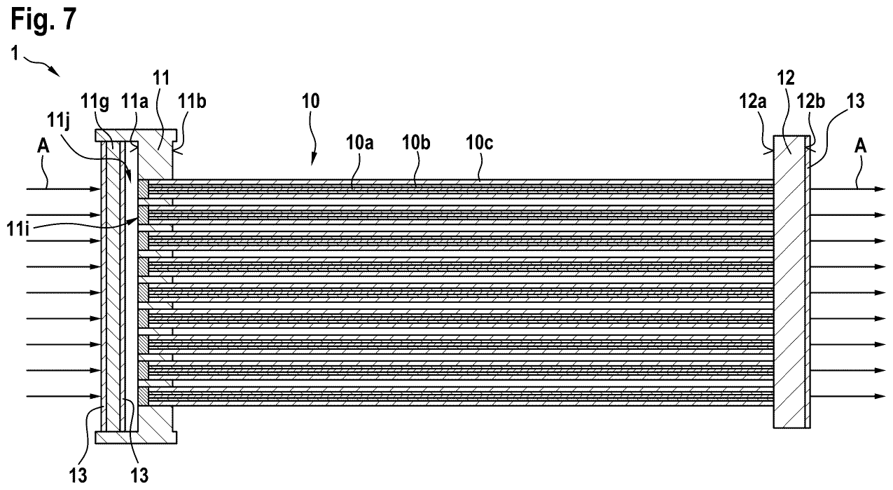

FIG. 7 a horizontal section through a beam guide device according to the invention according to a sixth exemplary embodiment;

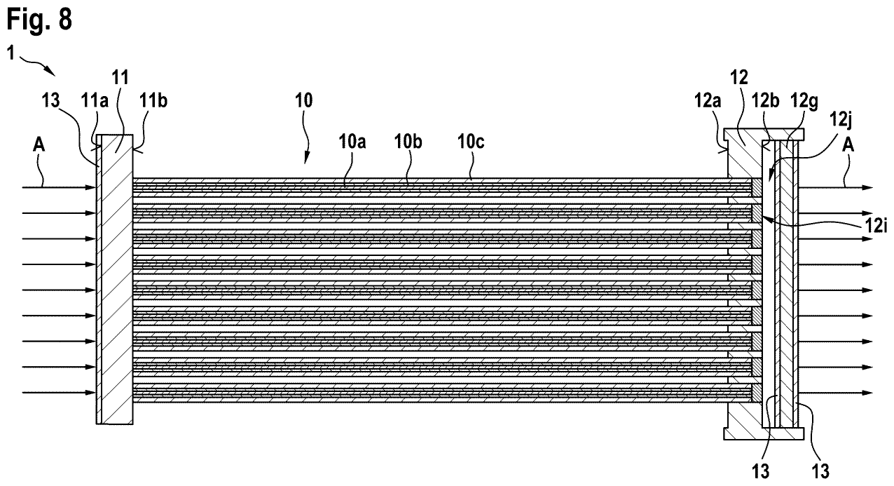

FIG. 8 a horizontal section through a beam guide device according to the invention according to a seventh exemplary embodiment;

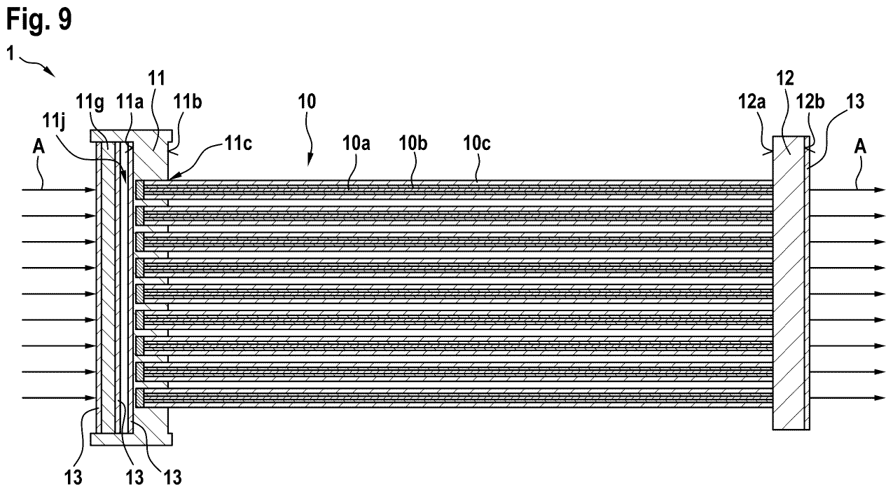

FIG. 9 a horizontal section through a beam guide device according to the invention according to an eighth exemplary embodiment;

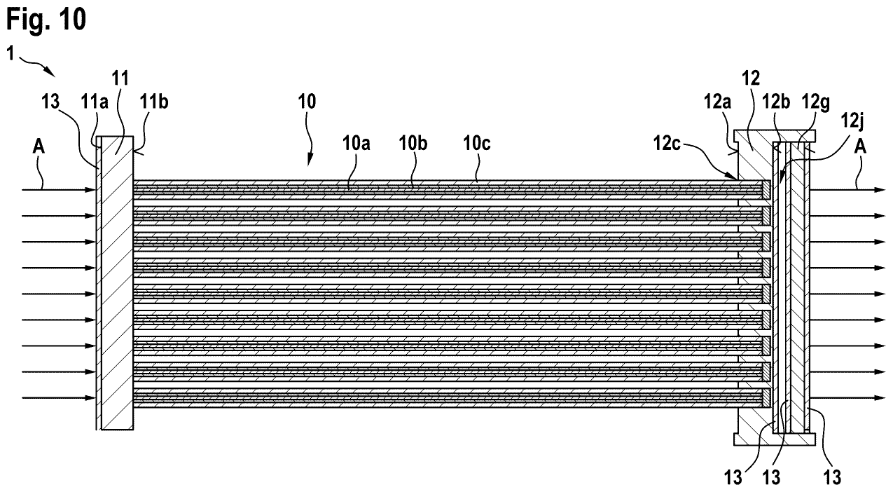

FIG. 10 a horizontal section through a beam guide device according to the invention according to a ninth exemplary embodiment;

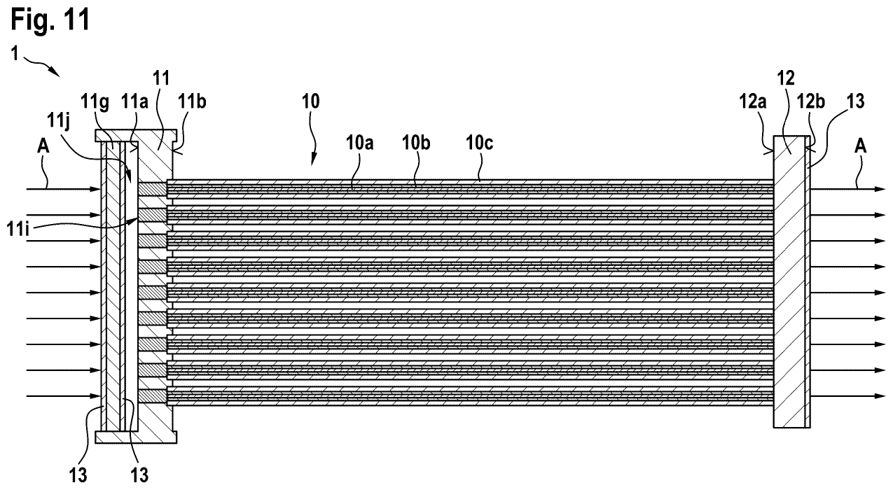

FIG. 11 a horizontal section through a beam guide device according to the invention according to a tenth exemplary embodiment;

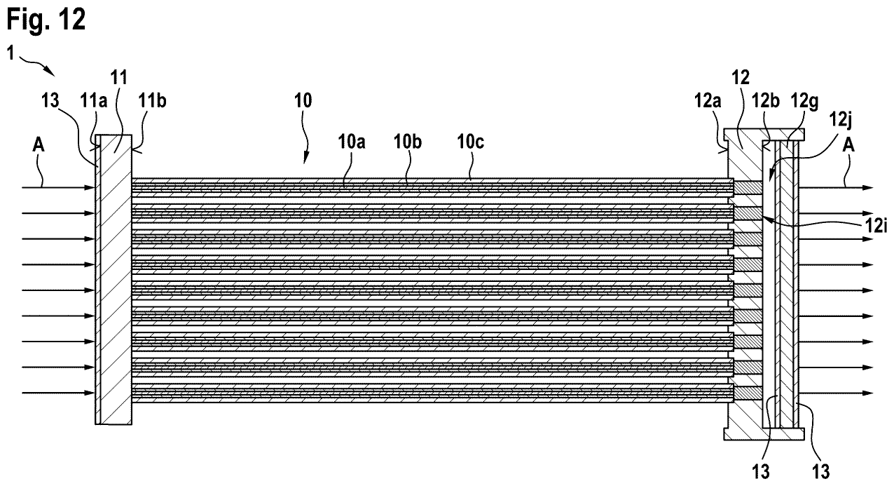

FIG. 12 a horizontal section through a beam guide device according to the invention according to an eleventh exemplary embodiment;

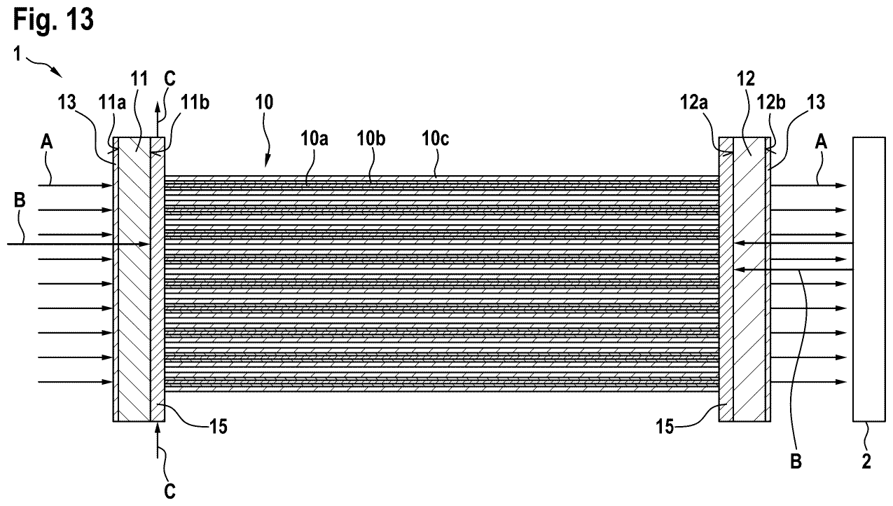

FIG. 13 a horizontal section through a beam guide device according to the invention according to a twelfth exemplary embodiment;

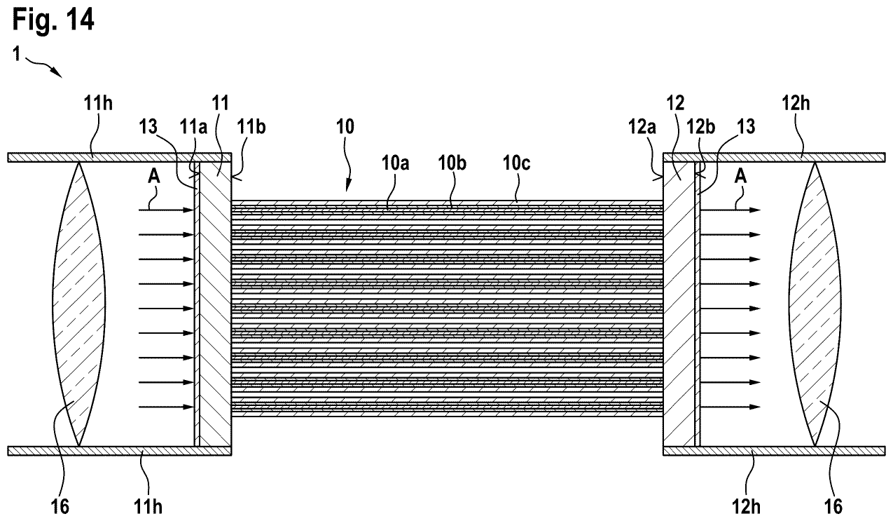

FIG. 14 a horizontal section through a beam guide device according to the invention according to a thirteenth exemplary embodiment;

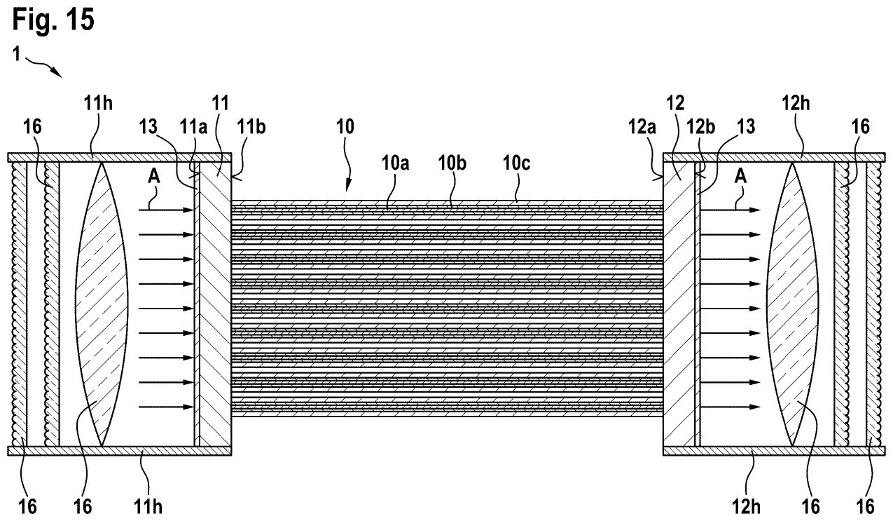

FIG. 15 a horizontal section through a beam guide device according to the invention according to a fourteenth exemplary embodiment;

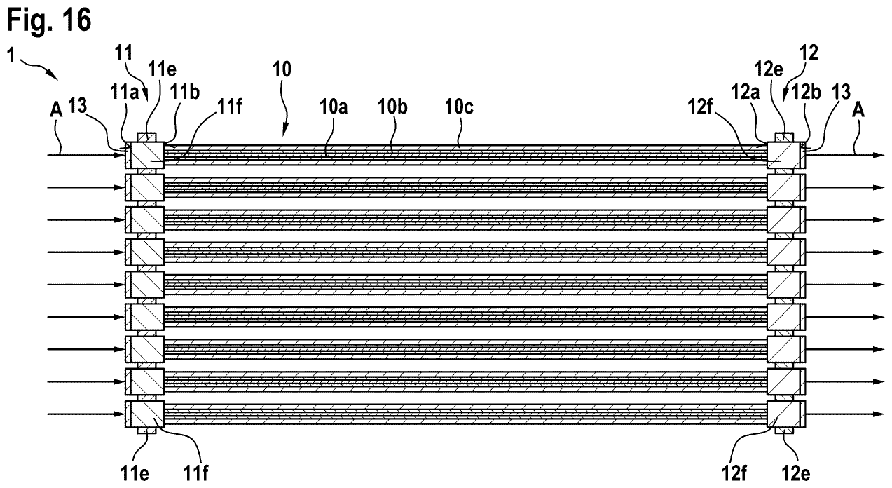

FIG. 16 a horizontal section through a beam guide device according to the invention according to a fifteenth exemplary embodiment;

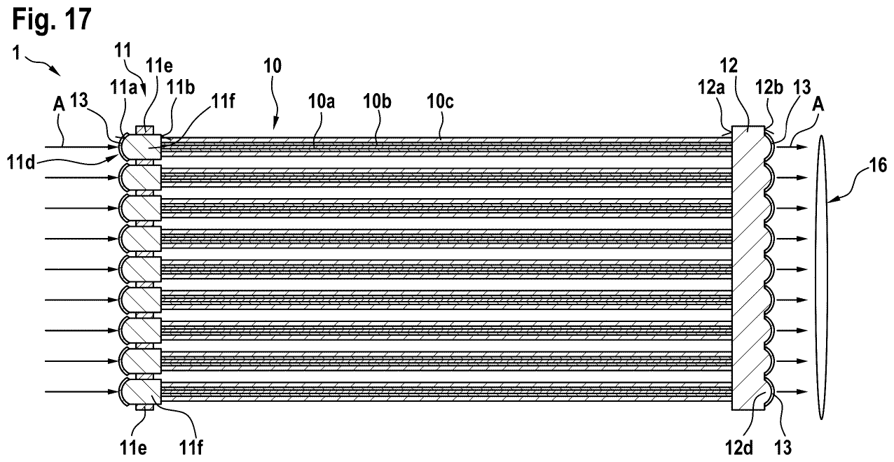

FIG. 17 a horizontal section through a beam guide device according to the invention according to a sixteenth exemplary embodiment;

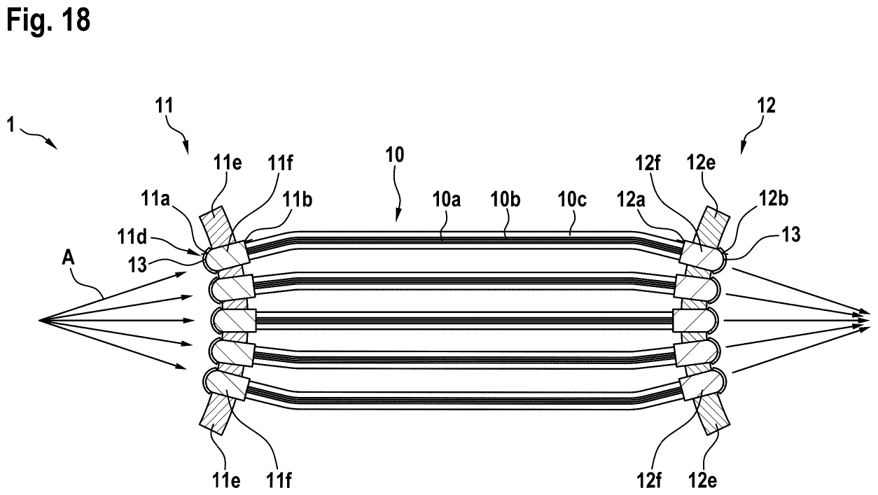

FIG. 18 a horizontal section through a beam guide device according to the invention according to a seventeenth exemplary embodiment;

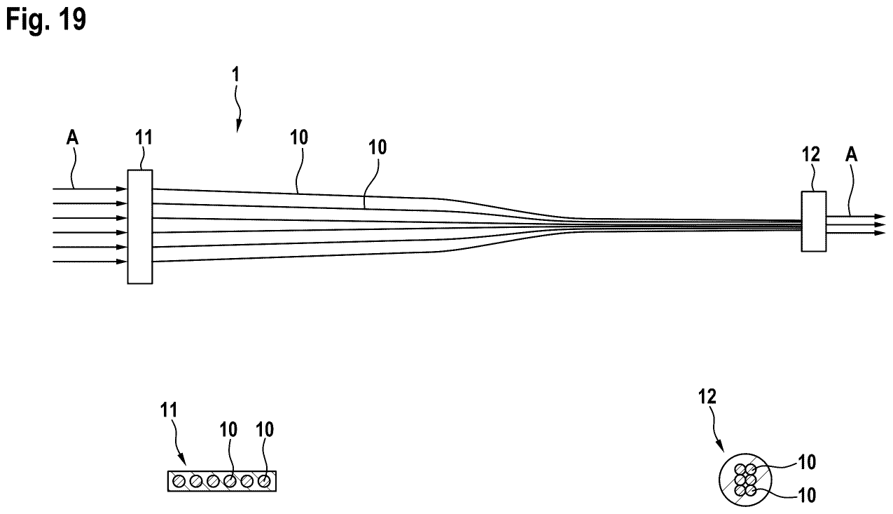

FIG. 19 a horizontal section through a beam guide device according to the invention according to an eighteenth exemplary embodiment;

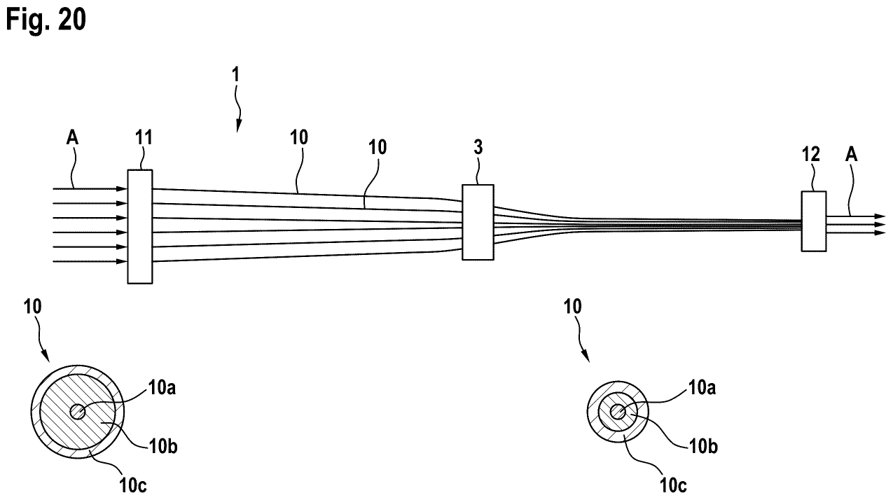

FIG. 20 a horizontal section through a beam guide device according to the invention according to a nineteenth exemplary embodiment;

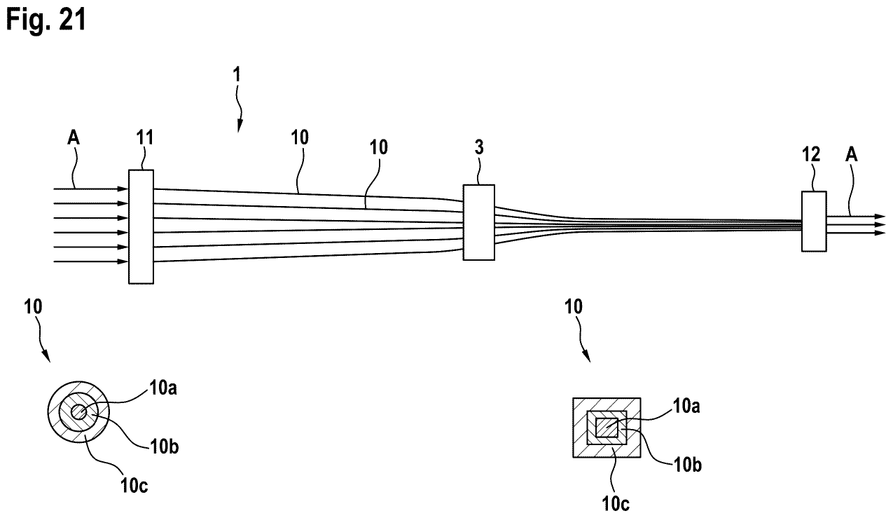

FIG. 21 a horizontal section through a beam guide device according to the invention according to a twentieth exemplary embodiment;

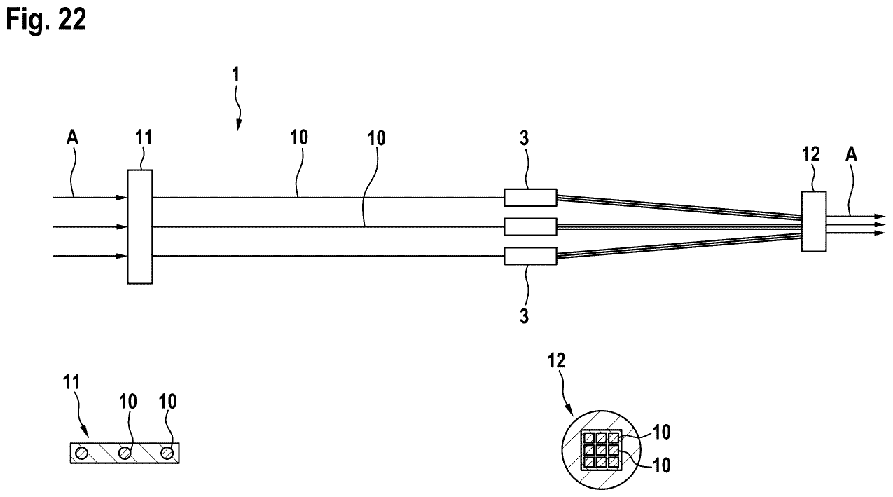

FIG. 22 a horizontal section through a beam guide device according to the invention according to a twenty-first exemplary embodiment with a signal radiation source;

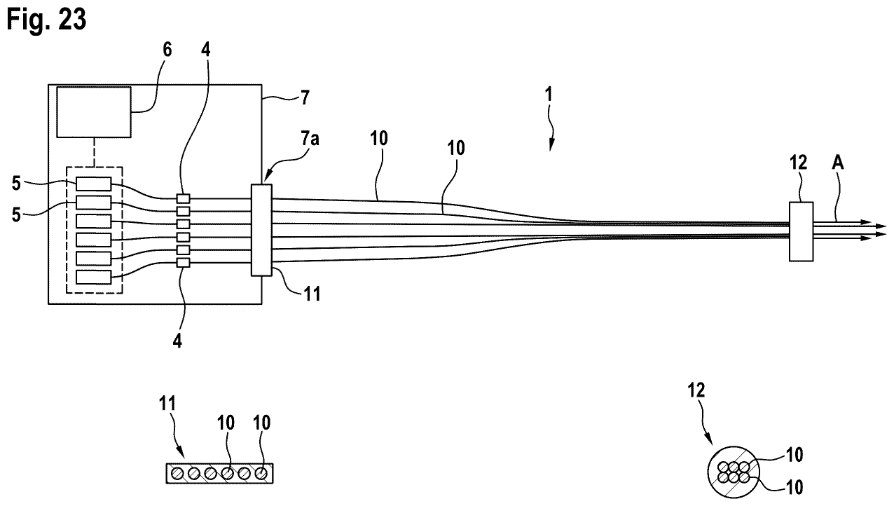

FIG. 23 a horizontal section through a beam guide device according to the invention according to a twenty-second exemplary embodiment with a signal radiation source;

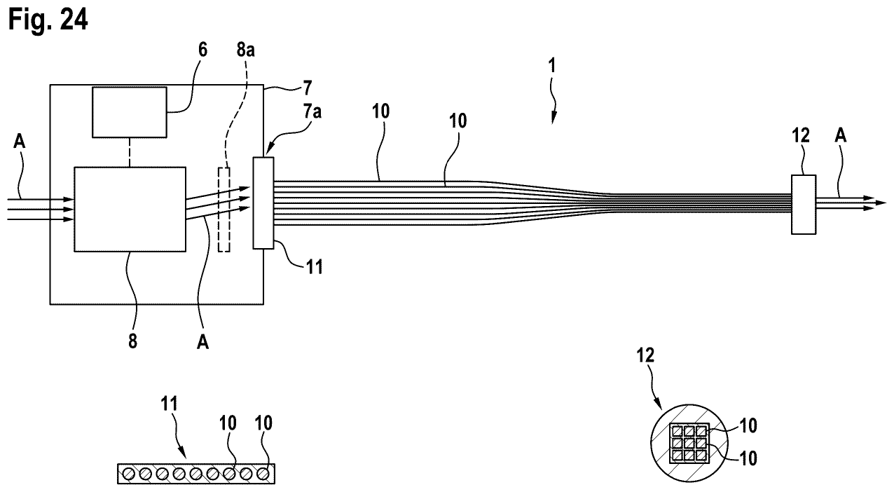

FIG. 24 a horizontal section through a beam guide device according to the invention according to a twenty-third exemplary embodiment with a signal radiation source;

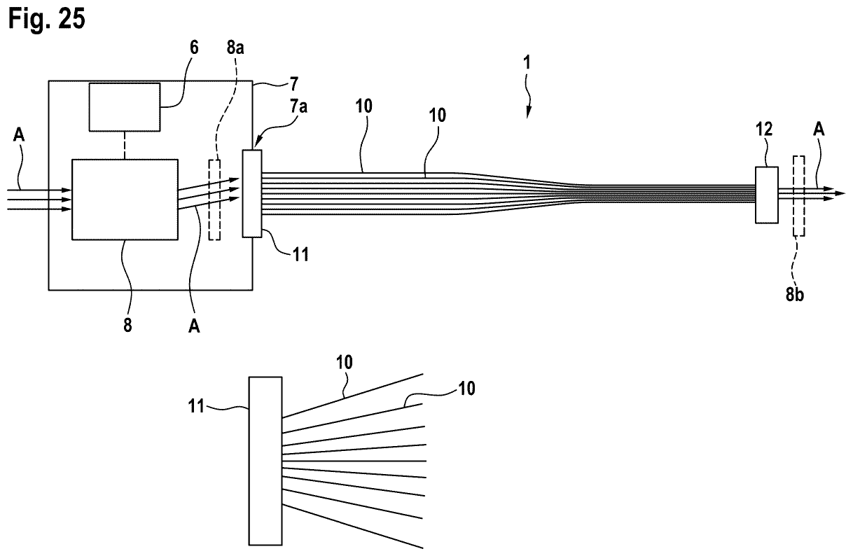

FIG. 25 a horizontal section through a beam guide device according to the invention according to a twenty-fourth exemplary embodiment with a signal radiation source;

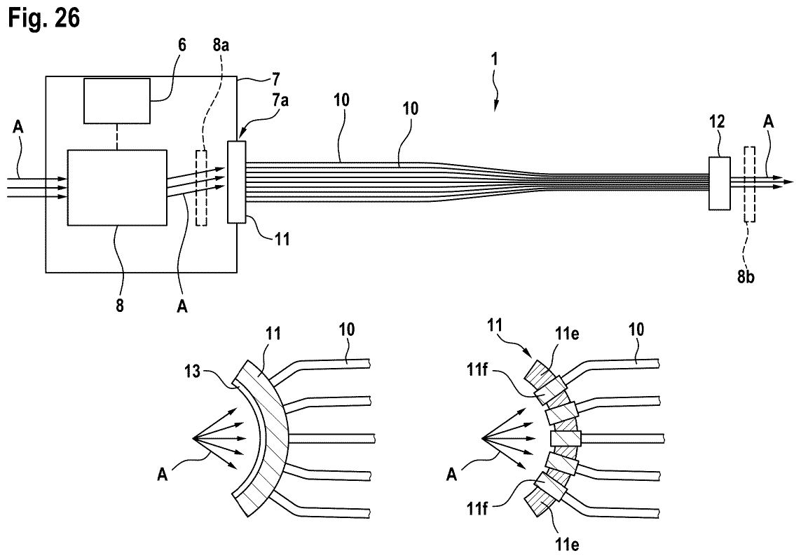

FIG. 26 a horizontal section through a beam guide device according to the invention according to a twenty-fifth exemplary embodiment with a signal radiation source; and

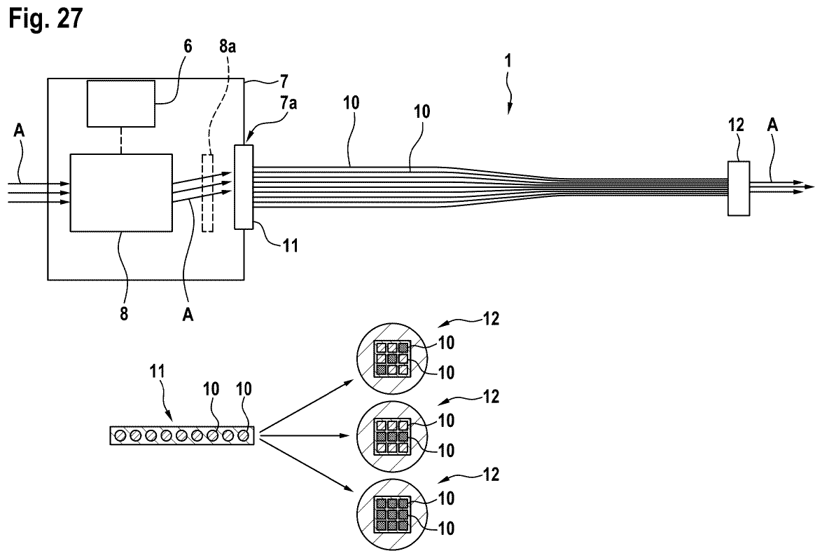

FIG. 27 a horizontal section through a beam guide device according to the invention according to a twenty-sixth exemplary embodiment with a signal radiation source.

FIG. 1 shows a perspective view of an application of a beam guide device 1 according to the invention in the form of a fiber-optic cable 1.

The application is a handling unit 9 in the form of an articulated-arm robot 9 with a base 90, multiple links 91 or arms 91 and an end effector unit 92 as a processing unit 92, which can be moved, positioned and aligned relative to the base 90 by means of the driven arms 91.

The beam guide device 1 according to the invention in the form of a fiber-optic cable 1 or a glass-fiber cable 1, as already mentioned, is connected at one end to a signal light amplifier 5a which receives multiple parallel signal light beams A in the form of laser light beams A and feeds them into the fiber-optic cable 1. The signal light beams A are guided parallel to one another via the fiber-optic cable 1 to its end, where the signal light beams A pass into the processing unit 92 in order to be directed by means of the processing unit 92 to a location for laser light processing.

According to the invention, the signal light beams A can be fed parallel to one another into the fiber-optic cable 1 according to the invention, and there forwarded or guided, and exit from the opposite end of the fiber-optic cable 1. In this case, the signal light radiation A can be influenced at the input, during guidance and/or at the exit as well as immediately thereafter, as will be described in more detail below with the aid of the various exemplary embodiments.

FIG. 2 shows a horizontal section through a beam guide device 1 according to the invention according to a first exemplary embodiment.

The beam guide device 1 or the fiber-optic cable 1 along its longitudinal extension direction consists substantially of a plurality of fiber elements 10 in the form of flexible fibers 10 or glass fibers 10, each with a fiber core 10a, a fiber cladding 10b surrounding the fiber core 10a and a fiber coating 10c surrounding the fiber cladding 10b. The fiber cores 10a and the fiber claddings 10b are made of quartz glass. The fiber coatings 10c consist of a softer material than glass, for example acrylate, silicone or polyimide.

At one end which during use faces the incoming signal light radiation A, the beam guide device 1 or the fiber-optic cable 1 has a fiber input element 11 as an elongated cuboid (see for example FIG. 19), with an input end 11a facing the incoming signal light radiation A and an opposite output end 11b. The corresponding ends of the fiber elements 10 are bonded by being welded to the surface of the output end 11b.

Likewise, the beam guide device 1 or the fiber-optic cable 1 has a fiber output element 12 along the fiber elements 10, wherein the adjacent ends of the fiber elements 10 are also bonded by being welded to the input end 12a thereof. The fiber output element 12 is also cuboid-shaped and has an output end 12b opposite the input end 12a, via which the signal light radiation A can exit to the outside of the beam guide device 1.

According to the invention, the fiber elements 10 can be defined in this way, in the present case in a row, and arranged at a distance from one another, so that the signal light beams A enter the beam guide device 1 parallel to one another through the fiber input element 11 or its input end 11a and there can pass directly into one of the fiber elements 10. The fiber elements 10 guide the signal light beams A through themselves and parallel to one another until the signal light beams A enter together into the fiber output element 12 and from there exit parallel to one another via its output end 12b as signal light radiation A into the environment of the beam guide device 1. This can constitute a particularly simple possibility for guiding the signal light radiation A, for example, from the signal light amplifier 5a to the application in FIG. 1.

To prevent reflections, both the input end 11a of the fiber input element 11 and the output end 12b of the fiber output element 12 have an optical coating 13 in the form of an anti-reflection coating 13.

FIG. 3 shows a horizontal section through a beam guide device 1 according to the invention according to a second exemplary embodiment.

In this case, compared to the first exemplary embodiment in FIG. 2, both the output end 11b of the fiber input element 11 and the input end 12a of the fiber output element 12 each have an optical coating 13 in the form of a reflection coating 13 or absorption coating 13 around the fiber elements 10 in order to prevent the unwanted entry of light from these two ends into the fiber input element 11 or into the fiber output element 12, since the signal light radiation A could be disturbed or influenced by this.

FIG. 4 shows a horizontal section through a beam guide device 1 according to the invention according to a third exemplary embodiment.

In this case, compared with the first exemplary embodiment in FIG. 2, a cladding light stripper 14 is arranged between the output end 11b of the fiber input element 11 and the corresponding ends (not designated) of the fiber elements 10 in order to remove unwanted pumped light from the fiber claddings 10b at this position, and accordingly keep it away from the fiber elements 10 or the signal light radiation A propagating there.

FIG. 5 shows a horizontal section through a beam guide device 1 according to the invention according to a fourth exemplary embodiment.

Compared to the third exemplary embodiment in FIG. 4, in this case the cladding light strippers 14 are arranged at the ends of the fiber elements 10, so that unwanted pumped light of the fiber claddings 10b can be kept directly away from the fiber output element 12.

FIG. 6 shows a horizontal section through a beam guide device 1 according to the invention according to a fifth exemplary embodiment.

In this case, compared with the first exemplary embodiment in FIG. 2, for each fiber element 10, the fiber input element 11 has a recess 11c in its output end 11b and the fiber output element 12 has a recess 12c in its input end 12a, into which the ends of the fiber elements 10 are each embedded and fused at that location with the fiber input element 11 or with the fiber output element 12. This can improve the material bond in each case.

FIG. 7 shows a horizontal section through a beam guide device 1 according to the invention according to a sixth exemplary embodiment.

In this case, the fiber output element 12 corresponds, for example, to the fiber output element 12 of the first exemplary embodiment in FIG. 2. The fiber input element 11, however, is designed significantly differently than in the previous exemplary embodiments. The fiber input element 11 has, on the one hand, through-openings 11i which pass through the fiber input element 11 along the propagation direction of the signal light radiation A and receive the corresponding ends of the fiber elements 10, but are offset by a predetermined amount into the through-openings 11i, where the ends of the fiber elements 10 are welded to the material of the fiber input element 11.

On the other hand, the edge (not designated) of the fiber input element 11 extends like a collar away from the fiber elements 10. In the area of the edge or collar, a spacer element 11g is arranged with a material bond, so that an intermediate space 11j or a distance 11j is created which can be gas-filled, liquid-filled, solid-filled or vacuum-filled. The spacer element 11g has optical coatings 13 in the form of anti-reflection coatings 13 on both sides.

The signal light radiation A can thus pass through the spacer element 11g into the intermediate space 11j, which is facilitated by the two anti-reflection coatings 13 of the spacer element 11g. In the intermediate space 11j, the signal light beams A can be influenced by the medium located there or by the transition at the boundary layers. The signal light beams A can then enter directly into the ends of the fiber elements 10 and propagate further there as previously described.

FIG. 8 shows a horizontal section through a beam guide device 1 according to the invention according to a seventh exemplary embodiment.

In this case, a spacer element 12g, an intermediate space 12j or a distance 12j, and through-openings 12i of the fiber output element 12 are provided on the fiber output element 12, as previously described with regard to the sixth exemplary embodiment in FIG. 7 for the fiber input element 11. The properties and advantages achieved there can alternatively or additionally be applied to the fiber output element 12 and implemented there.

FIG. 9 shows a horizontal section through a beam guide device 1 according to the invention according to an eighth exemplary embodiment.

This exemplary embodiment corresponds to the preceding sixth exemplary embodiment in FIG. 7 with the difference that instead of the through-openings 11i the fiber input element 11 now has recesses 11c which do not receive the ends of the fiber elements 10 right down to the bottom of the recesses 11c but rather at a slight distance therefrom. The surface of the input end 11a of the fiber input element 11, which is again continuous, has an optical coating 13, which also has an anti-reflection coating 13 in order to promote the passage of the signal light radiation A.

FIG. 10 shows a horizontal section through a beam guide device 1 according to the invention according to a ninth exemplary embodiment. In this case, the properties and advantages of the fiber input element 11 previously described with respect to the fiber input element 11 in FIG. 9 are applied to the fiber output element 12 according to FIG. 8, either alternatively or in combination.

FIG. 11 shows a horizontal section through a beam guide device 1 according to the invention according to a tenth exemplary embodiment.

This exemplary embodiment also corresponds to the sixth exemplary embodiment in FIG. 7, with the difference that the through-openings 11i extend significantly longer without receiving the fiber elements 10—receiving them only at the edge near the output end 11b of the fiber input element 11. The through-openings 11i also have a smaller cross-section than the fiber elements 10.

FIG. 12 shows a horizontal section through a beam guide device 1 according to the invention according to an eleventh exemplary embodiment. In this case, the properties and advantages previously described with respect to the fiber input element 11 in FIG. 11 are applied to the fiber output element 12 according to FIGS. 8 and 10, either alternatively or in combination.

FIG. 13 shows a horizontal section through a beam guide device 1 according to the invention according to a twelfth exemplary embodiment.

In this case too, the fiber output element 12 is based, for example, on the fiber output element 12 of the first exemplary embodiment in FIG. 2. In addition to the features shown and described there, the output end 11b of the fiber input element 11 has an absorption and reflection element 15 around the fiber elements 10 that is water-cooled by means of a cooling water flow C in order to reflect unwanted radiation B at this location and to absorb the non-reflected radiation B and to dissipate the corresponding thermal energy with the aid of the cooling water flow C.

In order to reflect and absorb radiation B reflected from a workpiece 2 in a comparable manner, the fiber output element 12 also has an absorption and reflection element 15 around the fiber elements 10, facing the fiber elements 10, which is however only passively air-cooled.

FIG. 14 shows a horizontal section through a beam guide device 1 according to the invention according to a thirteenth exemplary embodiment.

In this case, a pair of holders 11h of the fiber input element 11 extends toward the signal light radiation A. The holders 11h jointly hold, from diametrically opposite sides, an optical element 16 in the form of a collecting lens 16, through which the incoming signal light beams A pass before the signal light beams A then individually enter the fiber elements 10.

The fiber output element 12 also has a pair of holders 12h with a collecting lens 16 as an optical element 16 in order to also allow the exiting signal light beams A to pass through this collecting lens 16.

FIG. 15 shows a horizontal section through a beam guide device 1 according to the invention according to a fourteenth exemplary embodiment.

In this case, multiple optical elements 16 are arranged one behind the other per pair of holders 11h, 12h. At the end of the fiber input element 11, the signal light beams A successively pass first through a first microlens array 16, then through a second microlens array 16 and then through a collecting lens 16 before the signal light beams A each enter one of the fiber elements 10. At the fiber output element 12, the signal light beams A successively pass first through a collecting lens 16, then through a first microlens array 16 and then through a second microlens array 16 before the signal light beams A exit to the outside of the beam guide device 1.

FIG. 16 shows a horizontal section through a beam guide device 1 according to the invention according to a fifteenth exemplary embodiment.

In this case, the fiber output element 12 has the original configuration, for example, of the fiber output element 12 of the first exemplary embodiment in FIG. 2. However, the fiber input element 11 is formed on a plurality of linearly arranged single input elements 11f, wherein exactly one single input element 11f is provided per signal light beam A. The single input elements 11f are connected to the fiber input element 11 by means of a carrier 11e. This is also the case for the fiber output element 12, which accordingly has a plurality of linearly arranged single input elements 12f, which are connected to the fiber output element 12 by means of a carrier 12e.

FIG. 17 shows a horizontal section through a beam guide device 1 according to the invention according to a sixteenth exemplary embodiment.

In this case, each of the single input elements 11f of the fiber input element 11 according to the fifteenth exemplary embodiment in FIG. 16 of the incoming or incident signal light radiation A has an input lens 11d in order to focus the incoming signal light radiation A. The fiber output element 12 also has one output lens 12d per signal light beam A at its exit point 12b, wherein the fiber output element 12 in this case is again continuous/integrally formed.

FIG. 18 shows a horizontal section through a beam guide device 1 according to the invention according to a seventeenth exemplary embodiment.

This seventeenth exemplary embodiment is based on the preceding sixteenth exemplary embodiment in FIG. 17, wherein the carrier 11e of the fiber input element 11 is bent outwards. However, the fiber elements 10 then run parallel to each other again. As a result, the signal light radiation A can emanate from one point and then spread out to enter the corresponding input lens 11d of the corresponding single input element 11f of the fiber input element 11. The fiber output element 12 is designed in a comparable manner.

FIG. 19 shows a horizontal section through a beam guide device 1 according to the invention according to an eighteenth exemplary embodiment.

In this case, the fiber elements 10 are arranged linearly in or on the fiber input element 11 (see bottom left in FIG. 19), but then do not run completely parallel to each other, but rather change their arrangement to each other in the second dimension in the course of their elongated extension, so that a 2×3 matrix of two fiber elements 10 next to each other and three fiber elements 10 on top of each other arrives at or in the fiber output element 12 (see bottom right in FIG. 19), and is fastened there. On the other hand, the fiber elements 10 are arranged closer or denser to each other at the fiber output element 12. In this way, the resulting radiation of the individual signal light beams A can be influenced and, in particular, its power density can be increased.

FIG. 20 shows a horizontal section through a beam guide device 1 according to the invention according to a nineteenth exemplary embodiment.

In this case, the fiber elements 10 have a comparatively large-area fiber cladding 10b as the first strands of the fiber elements 10 starting from the fiber input element 11; see bottom left in FIG. 20. These strands of the fiber elements 10 end approximately in the middle between the fiber input element 11 and the fiber output element 12 and are connected to a connecting element 3 or to a transition element 3.

Second strands of the fiber elements 10, which have a smaller or thinner overall cross-section due to the smaller or thinner fiber cladding 10b, are arranged on the opposite side of the connecting element 3 (see bottom right in FIG. 20), in order to receive and transmit the corresponding signal light radiation A. This also makes it possible to achieve a denser arrangement of the emerging signal light beams A or of the resulting signal light radiation A of the individual signal light beams A with a higher power density.

FIG. 21 shows a horizontal section through a beam guide device 1 according to the invention according to a twentieth exemplary embodiment.

This exemplary embodiment is comparable to the previous exemplary embodiment in FIG. 20, except that in this case the second strand of the fiber elements 10 has a rectangular cross-section; see bottom right in FIG. 21.

FIG. 22 shows a horizontal section through a beam guide device 1 according to the invention according to a twenty-first exemplary embodiment.

In this case, one connecting element 3 or one transition element 3 is provided per first strand of the fiber elements 10. For each connecting element 3, three strands per fiber element 10 are integrally connected to the connecting element 3 from the opposite side (see bottom left in FIG. 22), so that the signal light radiation A of a first strand of a fiber element 10 is divided into three second strands per fiber element 10. The first strands of the fiber elements 10 are arranged next to each other. The three-by-two second strands of the fiber elements 10 are arranged next to and above each other as a 3×3 matrix, wherein the second strands of the fiber elements 10 are arranged one above the other, i.e. each running horizontally; see bottom right in FIG. 22.

FIG. 23 shows a horizontal section through a beam guide device 1 according to the invention according to a twenty-second exemplary embodiment with a signal radiation source 5.

More precisely, each individual signal light beam A is generated by its own signal radiation source 5 in the form of a fiber laser 5 or a diode laser 5. The signal radiation sources 5 are controlled or operated by a control unit 6. Each signal light beam A is guided by a glass fiber to a fiber coupler 4, to a fiber switch 4 or to a fiber coupling 4, in order to be coupled out there and emitted to the fiber input element 11 as previously described, i.e. according to one of the exemplary embodiments. The fiber input element 11 is arranged in a housing passage 7a of a housing 7, which accommodates the previously described components.

In this case, six fiber elements 10 are provided, which are arranged next to one another, i.e. in a row, and are laterally spaced apart from one another and connected to the fiber input element 11; see bottom left in FIG. 23. Along their elongated course, the fiber elements 10 are guided closer to one another and in two layers of three fiber elements 10 each, so that the fiber elements 10 are connected to the fiber output element 12 as a 2×3 matrix (see bottom right in FIG. 23), and the signal light beams A in this constellation emerge compactly and rectangularly as outgoing signal light radiation A and/or from a processing unit 92 (see FIG. 1) into the environment and/or towards the workpiece 2.

FIG. 24 shows a horizontal section through a beam guide device 1 according to the invention according to a twenty-third exemplary embodiment with a signal radiation source 5.

In this case, the signal light beams A from a signal light source 5 (not shown) enter the housing 7 through an open or transparent opening (not shown) and there reach a beam guidance and deflection unit 8, which can feed the signal light beams A by means of a deflecting element 8a to different fiber elements 10, which are connected to the fiber input element 11. More precisely, three signal light beams A are fed to the beam guidance and deflection unit 8, and there are nine fiber elements 10 which are arranged in a row next to one another at the fiber input element 11 (see bottom left in FIG. 24), and form a 3×3 matrix in the course of the beam guide device 1 at the fiber output element 12; see bottom right in FIG. 24.

If the three signal light beams A are thus fed to the left-hand three fiber elements 10 of the fiber input element 11, the signal light beams A reach the upper row of fiber elements 10 at the fiber output element 12. If the three signal light beams A are fed to the middle three fiber elements 10 of the fiber input element 11, the signal light beams A reach the middle row of fiber elements 10 at the fiber output element 12. If the three signal light beams A are fed to the right-hand three fiber elements 10 of the fiber input element 11, the signal light beams A reach the lower row of fiber elements 10 at the fiber output element 12. In this way, a comparatively simple control can be realized by feeding the signal light beams A to different locations along the beam guide device 1.

FIG. 25 shows a horizontal section through a beam guide device 1 according to the invention according to a twenty-fourth exemplary embodiment with a signal radiation source 5.

The illustration in FIG. 25 corresponds to the preceding illustration in FIG. 24 with the difference that the fiber elements 10 do not point straight or in a straight line away from the fiber input element 11, but rather run obliquely (see below in FIG. 25), which can make possible a compact connection and/or attachment of the fiber elements 10 to the fiber input element 11 with subsequent expansion of the fiber elements 10.

Furthermore, after the fiber output element 12, a further optical output element 8b is provided for influencing the emerging signal radiation A.

FIG. 26 shows a horizontal section through a beam guide device 1 according to the invention according to a twenty-fifth exemplary embodiment with a signal radiation source 5.

The illustration in FIG. 26 corresponds to the preceding illustration in FIG. 25 with the difference that the fiber input element 11 is curved or concave, so that the signal light beams A can be forwarded in, as it were, a star shape from the deflection element 8a and enter each of the fiber elements 10 in a straight line. The fiber elements 10 then run parallel to each other; see bottom left in FIG. 26.

Alternatively, for this purpose, multiple single input elements 11f can be arranged in an arc shape by means of a curved carrier 11e (see bottom right in FIG. 26), as already explained with regard to the seventeenth exemplary embodiment in FIG. 18.

FIG. 27 shows a horizontal section through a beam guide device 1 according to the invention according to a twenty-sixth exemplary embodiment with a signal radiation source 5.

The twenty-sixth exemplary embodiment in FIG. 27 subsumes the twenty-third exemplary embodiment in FIG. 24, wherein by means of the deflection element 8a, other constellations or combinations of fiber elements 10 can also be supplied with the signal light radiation A (see bottom right in FIG. 27), so that not only straight horizontal signal light radiation A can be generated at the output of the fiber output element 12 (see bottom right, center in FIG. 27) but also a diagonal course can be created; see bottom right top in FIG. 27. All fiber elements 10 can also be supplied simultaneously (see bottom right in FIG. 27), if sufficient signal light radiation A is provided.

### LIST OF REFERENCE SIGNS (Part of the Description)

A Signal light beams, laser light beams
B Absorbed and/or reflected radiation
C Cooling water flow
1 Beam guide device; fiber-optic cable; glass-fiber cable
10 Fiber elements; flexible fibers; glass fibers
10a Fiber cores
10b Fiber claddings
10c Fiber coatings
11 Fiber input element
11a Input end of the fiber input element 11 and/or of the single input elements 11f
11b Output end of the fiber input element 11 and/or of the single input elements 11f
11c Recesses in the output end 11b of the fiber input element 11
11d Input lenses
11e Carrier of the single input elements 11f
11f Single input elements
11g Spacer element
11h Holder
11i Through-openings of the fiber input element 11
11j Intermediate space; distance
12 Fiber output element
12a Input end of the fiber output element 12 and/or of the single output elements 12f
12b Output end of the fiber output element 12 and/or of the single output elements 12f
12c Recesses in the output end 12b of the fiber output element 12
12d Output lenses
12e Carrier of the single output elements 12f
12f Single input elements
12g Spacer element
12h Holder
12 Through-openings of the fiber output element 12
12j Intermediate space; distance
13 Optical coating; anti-reflection coating; reflection coating; absorption coating
14 Cladding light strippers
15 Absorption and/or reflection element
16 Optical element and/or lens; collecting lens; microlens array; optical elements and/or lenses
2 Workpiece
3 Connecting element; transition element
4 Fiber coupler; fiber switches; fiber coupling
5 Signal light sources; fiber lasers; diode lasers
5a Signal light amplifier
6 Control unit
7 Housing
7a Housing passage
8 Beam guidance and deflection unit
8a Deflection element
8b Optical output element
9 Handling unit; articulated-arm robot
90 Base
91 Links; arms
92 End effector unit; processing unit

1. A beam guide device for guiding signal light radiation
having at least one fiber input element which is designed to receive the signal light radiation,
having at least one fiber output element which is designed to emit the signal light radiation, and
having a plurality of fiber elements which are fixed at one end to the fiber input element and at the opposite end to the fiber output element and are designed to guide the signal light radiation from the fiber input element to the fiber output element.

2. A beam guide device according to claim 1,
wherein the ends of the fiber elements are fused in the fiber input element and/or in the fiber output element.

3. A beam guide device according to claim 1,
wherein the fiber input element has one recess or one through-opening per fiber element, facing the fiber elements, in which the end of the fiber element is received, and/or
wherein the fiber output element has one recess or one through-opening for each fiber element, facing the fiber elements, in which the end of the fiber element is received.

4. A beam guide device according to claim 1,
wherein at least some, preferably all, fiber elements have at least one cladding light stripper,
wherein the cladding light strippers are preferably arranged on the fiber input element and/or on the fiber output element.

5. A beam guide device according to claim 1,
wherein the fiber input element has an optical coating, preferably an anti-reflection coating, facing away from the fiber elements, and/or
wherein the fiber output element has an optical coating, preferably an anti-reflection coating, facing away from the fiber elements.

6. A beam guide device according to claim 1,
wherein the fiber input element has an optical coating, preferably a reflection coating and/or an absorption coating, facing the fiber elements, around the fiber elements and/or
wherein the fiber output element has an optical coating, preferably a reflection coating and/or an absorption coating, facing the fiber elements, around the fiber elements.

7. A beam guide device according to claim 1,
wherein the fiber input element has at least one, preferably air- or water-cooled, absorption and/or reflection element, facing the fiber elements, around the fiber elements, and/or
wherein the fiber output element has at least one, preferably air- or water-cooled, absorption and/or reflection element, facing the fiber elements, around the fiber elements.

8. A beam guide device according to claim 1,
wherein the fiber input element has one input lens for each incoming beam of signal light radiation, preferably provided with an optical coating, preferably with an anti-reflection coating, facing away from the fiber elements, and/or
wherein the fiber output element has one output lens for each exiting beam of the signal light radiation, preferably provided with an optical coating, preferably with an anti-reflection coating, facing away from the fiber elements.

9. A beam guide device according to claim 1,
wherein the fiber input element has a single input element per fiber element,
wherein the single input elements are permanently connected to one another by means of a carrier, and/or
wherein the fiber output element has a single output element per fiber element,
wherein the single fiber output elements are permanently connected to one another by means of a carrier.

10. A beam guide device according to claim 9,
wherein the carrier comprises, preferably consists of, glass, metal or ceramic.

11. A beam guide device according to claim 9,
wherein the carrier has at least in portions, preferably substantially, a preferably optically reflective and/or optically adsorbent surface coating.

12. A beam guide device according to claim 1,
wherein the fiber input element has at least one spacer element which runs perpendicular to the fiber elements and is designed to receive the signal light radiation and to emit it to the fiber elements,
wherein the spacer element is spaced apart from the fiber elements by a preferably open, gas-filled, liquid-filled, solid-filled or vacuumed intermediate space, and/or
wherein the fiber output element has at least one spacer element which runs perpendicular to the fiber elements and is designed to receive the signal light radiation from the fiber elements and to emit it away from the beam guide device,
wherein the spacer element is spaced apart from the fiber elements by a preferably open, gas-filled, liquid-filled, solid-filled or vacuumed intermediate space.

13. A beam guide device according to claim 12,
wherein the fiber elements facing the spacer element are connected to the intermediate space through through-openings of the fiber input element or of the fiber output element, preferably recessed, or
wherein the fiber elements are received, facing the spacer element, by recesses of the fiber input element or of the fiber output element, preferably recessed.

14. A beam guide device according to claim 1,
further comprising at least one optical element, preferably having at least one collecting lens, which is arranged at a distance from the fiber elements facing away from the fiber input element by means of a holder and is designed to receive some, preferably all, incoming rays of the signal light radiation, and/or
further comprising at least one optical element, preferably having at least one collecting lens, which is arranged at a distance from the fiber elements facing away from the fiber output element by means of a holder and is designed to receive some, preferably all, emerging rays of the signal light radiation.

15. A beam guide device according to claim 14,
wherein the optical element is a microlens array,
wherein the microlens array has one microlens per fiber element, multiple microlenses per fiber element or a shared microlens for multiple fiber elements.

16. A beam guide device according to claim 1,
further comprising a single lens per fiber element of some, preferably all, fiber elements, each arranged at a distance from the fiber elements, facing away from the fiber input element or the fiber output element, and each designed to receive exactly one emerging beam of the signal light radiation.

17. A beam guide device according to claim 1,
wherein some, preferably all, fiber elements at the fiber input element are spaced apart from one another differently, preferably at a greater distance, than at the fiber output element.

18. A beam guide device according to claim 1,
wherein some, preferably all, fiber elements at the fiber input element have a different spatial arrangement in relation to one another than at the fiber output element.

19. A beam guide device according to claim 18,
wherein some, preferably all, fiber elements are arranged one-dimensionally in relation to each other at the fiber input element and two-dimensionally in relation to each other at the fiber output element.

20. A beam guide device according to claim 1,
wherein some, preferably all, fiber elements are in each case cylindrical and are formed with a larger cross-section at the fiber input element, preferably with regard to a fiber core, a fiber cladding and/or a fiber coating, than at the fiber output element.

21. A beam guide device according to claim 1,
wherein some, preferably all, fiber elements are in each case formed at the fiber input element with a different contour than at the fiber output element.

22. A beam guide device according to claim 1,
wherein some, preferably all, fiber elements are in each case divided multiple times between the fiber input element and the fiber output element.

23. A beam guide device according to claim 20,
wherein some, preferably all, fiber elements are formed in two parts and are connected to one another, preferably approximately centrally between the fiber input element and the fiber output element or closer to the fiber input element or to the fiber output element, by means of a connecting element, preferably with a material bond.

24. A beam guide device according to claim 1,
wherein some, preferably all, fiber elements are individual flexible fibers, preferably glass fibers, which are held all-together or in bundles by a flexible material, particularly preferably enclosed by a cladding, and
wherein the beam guide device is a fiber-optic cable, preferably a glass-fiber cable.

25. A beam guide device according to claim 1,
wherein some, preferably all, fiber elements are aligned obliquely in relation to the fiber input element and/or to the fiber output element.

26. A beam guide device according to claim 1,
wherein the fiber input element and/or the fiber output element is/are curved,
wherein the fiber elements are preferably aligned parallel to the surface normal of the fiber input element and/or of the fiber output element.

27. A device having at least one beam guide device according to claim 1.
